(19) United States
(12) Patent Application Publication
(10) Pub. No.: US 2006/0232060 A1
(43) Pub. Date: Oct. 19, 2006

(54) Pressure sensitive packing laminate overlay form combination and method of using same

(75) Inventor: D. Mark Tucker, Fort Scott, KS (US)

Correspondence Address: WARD/KRAFT, INC., 2401 COOPER STREET, P. O. BOX 938, FT. SCOTT, KS, 66701, US

(73) Assignee: ASSIGNEE1

(21) Appl. No.: 11/105,083

(22) Filed: Apr. 13, 2005

(51) Int. Cl. B42D 15/00

(52) U.S. Cl. 283/101

(57) ABSTRACT

A pressure sensitive overlay laminate assembly is provided for use in creating shipping documents for an automated packaging line. The overlay assembly includes first and second portions that are juxtaposed one on the other after imprinting so that the shipping information is temporarily, centrally disposed beneath the overlay or shipping information portion. The first and second portions are provided on a single carrier web and spaced from one another in a machine direction to facilitate printing and placing by the automated application line.

### CROSS-REFERENCES TO RELATED APPLICATIONS

None.

### FIELD OF THE INVENTION

The present invention is found in the field of business forms, more particularly business communication documents that are utilized in the packing and delivery of goods to an end user. The construction of the form assembly is adapted to be used by automated processing equipment that has the ability to successively print information on a packing list and then apply or print address indicia on an overlay that is used to conceal the packing list from view. The packing list is placed on the carton or box that contains the materials that are to be shipped and then the system places the overlay on top of the packing list fully concealing the packing list from view.

### BACKGROUND OF THE INVENTION

There are numerous business form constructions and assemblies that are available for use in shipping and delivering goods to consumers and end users. These configurations have been produced in many arrangements depending on the particular needs of the user of the business form construction.

Early form constructions, such as that exhibited in U.S. Pat. No. 1,901,495, included a two part arrangement in which a first part, such as a letter to a recipient, is used to address the package and then a label which an opening is placed over the letter such that the address shows through an opening in the label while the label is used to secure the letter to the package.

A more common approach has been to use what is known in the industry as “a multiple part form” combination such as that shown in U.S. Pat. No. 3,987,960. In this construction, a number of plies are provided in a single construction and are connected to one another through one or more common margins. The plies are separated from the marginal stub through the use of one or more lines of weakness. An impact printer or stylus is then used to impart information to the upper ply and either carbon interleaves or carbonless coated sheets are used to enable the image imparted to the uppermost ply to pass through to lower plies to create record copies of the information. In use, an adhesive layer on the back of the assembly is exposed by removing liner material and one or more of the record plies are inserted into an attached envelope and then the label with the inserted plies is attached to the package and the package is shipped.

A still further form of shipping label is a single ply of material such as that shown in U.S. Pat. No. 5,730,469, in which the packing list information and shipping information are printed on the face of separate panels of the assembly. Next, the packing information is folded under the “ship to” address portion (recipients address) in an accordion fashion so that the packing information is concealed beneath the ship to portion. Finally, adhesive is used to secure the assembly to the package.

Unfortunately, problems still exist with such prior art constructions in that each of the foregoing assemblies, while efficient, require human intervention, such as the placing of the windowed label over the letter; separating and inserting the plies; and folding panels prior to using the assembly for the intended purpose. As might be expected, in an environment where a significant number of packages are to be shipped on a daily or recurring basis, such human intervention may prove to be impractical due to speed considerations and costly in requiring additional employees to complete the shipping function.

Shipping and packing lists have also been developed that can be used with automated processing lines. An example of such a system is disclosed in U.S. Pat. No. 6,616,189. In this particular system separate, distinct webs of material are used to advance either a shipping label or a packing list to an automated printer applicator. Each web requires its own printer applicator and a packing list is first printed and then applied to a carton and if required additional packing lists are applied over the first packing list. Then the carton is advanced to another station and a shipping label is applied over the one or more packing lists.

The foregoing system is very effective in high volume operations where multiple packaging lists are often needed to be generated, e.g. consumer electronics, mechanical fasteners, and the like. However, such expensive systems fail to meet the needs of mid-size operations. These high volume operations require elaborate hardware in the form of separate printer applicators for each web of material (as well as separate support equipment and integration requirements) that is being fed to the packing area. Coupled with the foregoing is the need to provide expensive programming for each applicator as well as the devices that are used to feed the separate webs of material to the application area.

Publications, patents and patent applications are referred to throughout this disclosure. All references cited herein are hereby incorporated by reference.

What is needed therefore is an assembly system that is capable of generating packing and shipping lists in an efficient and effective manner without encountering the foregoing drawbacks.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention is directed to an innovative, simple solution that is targeted for use with automated processing lines and requires less equipment than other known conventional application systems. The assembly described in the instant specification is provided in an intermediate condition on a single liner or carrier web and each intermediate assembly is placed in a particular sequence that includes first a packing list and a second, portion including a shipping overlay label. Multiple sequences of the intermediates are then provided on a continuous web of material. The components are sized and configured such that the first part or packing list fits substantially, entirely, and centrally beneath the second part, and is retained temporarily (through use of the adhesive patterns provided on the margins) until removed through the use of one or more lines of weakness. Removal of the shipping label will result in the disclosing of the contents of the package to which the laminate assembly has been applied.

In one exemplary embodiment, a pressure sensitive packing list overlay assembly, is provided and includes a carrier web that has first and second faces, a width, and a length. The first face of the carrier web is coated with a release material and the second face is uncoated. One of the first and second faces may be provided with a pair of sense marks so as to be discernable by an electronic sensor. The sense marks are spaced from one another a first distance that is substantially equal to a length of a pressure sensitive overlay assembly. Alternatively, the sense marks may be applied directly to the carrier web and may be positioned on either side of the carrier web depending on placement of the sensor to detect the marks. A still further alternative is to simply use the leading or trailing edge of on or more of the packing list and the shipping overlay. Thus, as used herein the term “marks” can be printed sense indicators or leading/trailing edges of the intermediate.

The pressure sensitive overlay assembly of the presently described embodiment includes a packing list and a shipping overlay that are spaced from one another a second distance on the first face of the carrier web, in a direction of machine travel or machine feeding direction, that is less than the first distance, or the distance between the sense marks or areas between the leading and trailing edges of the packing list and shipping overlay, respectively. The packing list, shipping overlay and spacing between the two are substantially equal to a length of a complete pressure sensitive overlay intermediate assembly.

The packing list of this embodiment has first and second faces, first and second longitudinally extending sides and first and second transversely extending edges. The packing list has a width and length that is used to create a packing list area that has a first dimension. The second or back face of the packing list is provided with a pressure sensitive adhesive in at least the marginal areas along the longitudinally extending sides, thus leaving a central portion of the packing list second face substantially devoid of adhesive. The first face of the packing list is provided with variable indicia relating to contents of the package to which the shipping overlay assembly has been provided.

The shipping overlay has first and second faces, first and second longitudinally extending sides and first and second transversely extending edges. The shipping overlay has a width and length that creates a shipping overlay area that has a second dimension, which is greater than the first dimension of the packing list.

The second face of the shipping overlay is provided with a pattern adhesive along marginal areas of each of the first and second longitudinally extending sides and the first and second transversely extending edges. The pattern of adhesive extends inwardly from each of the sides and end edges, with each of the marginal areas of the longitudinally extending sides being substantially equal and the marginal areas of the transversely extending ends being substantially equal.

First and second longitudinally extending lines of weakness are provided inwardly of the first and second longitudinally extending sides to create marginal areas. First and second transversally extending lines of weakness are provided inwardly of each of the first and second transversely extending edges of the shipping overlay marginal areas to create marginal areas and are spaced inwardly from the edges. The lines of weakness cooperate to form an outer perimeter of an adhesive free area greater in size or dimension than the first adhesive free area of the packing list, and the adhesive free area of the packing list is disposed substantially, centrally of the shipping overlay adhesive free area.

The carrier web has a plurality of repeating predefined sequence arrangements of the packing list followed by the shipping overlay that are spaced from one another in a machine travel direction of less than two inches.

In the exemplary embodiment, the shipping overlay is provided with a third transversely extending line of weakness that is spaced from, and parallel to, one of the first and second transversely extending lines of weakness.

The first and second longitudinally extending lines of weakness are contained entirely within the second dimension of the shipping overlay and each of the lines of weakness has a length that is greater than the length of the packing list.

In a further exemplary embodiment, the present invention pressure sensitive package delivery construction is described and includes a package suitable for delivery via a courier service. The package must have at least one exposed surface that is suitable for receiving a pressure sensitive laminate assembly which provides delivery instructions and content information.

The pressure sensitive laminate assembly of the presently described embodiment is provided on a single, continuous web. The pressure sensitive assembly includes first and second portions that are placed on the web in an alternating and repeating fashion and together, along with the spacing between the two portions define a length of an intermediate assembly that are used to construct the laminate assembly. The length of the intermediate assembly is greater than combined lengths of the first and second portions.

In this embodiment, the first portion has a first length and width that creates a first area. The first portion has first and second faces, first and second ends and first and second sides. The second face is provided with regular patterns of pressure sensitive adhesive that are spaced from one another and create at least one adhesive free area between the patterns. The at least one adhesive free area is further defined by plural lines of weakness that create outer edges of the adhesive free area.

Continuing with the presently described embodiment, the pressure sensitive laminate assembly includes a second portion that has a first length and width which creates a second area larger than the first area. The second portion includes first and second faces, first and second ends and first and second sides. The second face is provided with regular patterns of pressure sensitive adhesive that are spaced from one another and create at least one adhesive free area between the patterns. The adhesive free area of the second portion is larger than the adhesive free area of the first portion. The adhesive free area is further defined by plural lines of weakness that create outer edges of the adhesive free area.

Each of the first and second portions of this presently described embodiment of the pressure sensitive laminate are removed from the single carrier web and placed on the exposed surface of the package such that the first portion is placed substantially, centrally, temporarily beneath the second portion. The first portion is removed subsequent to second portion being removed by the lines of weakness.

In this embodiment, the plural lines of weakness of the second portion are in substantial parallel alignment when the second portion is juxtaposed on the first portion. In addition, the adhesive free area of the first portion is in substantial parallel alignment with the adhesive free portion of the second portion when the second portion is juxtaposed on the first portion.

In a yet further exemplary embodiment of the present invention, a pressure sensitive shipping assembly intermediate is described and includes a carrier web that has first and second surfaces. The carrier web constructed from highly calendared cellulosic stock, and has a coating of release material on the first face. The carrier web is provided with a plurality of repeating sequences of length, in a machine direction, each of the sequences have first and second portions.

The carrier web of the presently described embodiment is further provided with first and second intermediate segments that are spaced from one another in the machine direction a distance of less than a length in the machine direction equal to the first portion of the repeating sequence.

In this embodiment, a first intermediate has first and second faces disposed within the first portion of one of the repeating sequences of the carrier web and occupies less than half of the repeating sequence in which it is positioned. The first intermediate has a longitudinal direction and a transverse direction that is less than the longitudinal direction. The longitudinal direction of the first is placed in the machine direction of the carrier web and occupies less than half of the area of the intermediate.

The first intermediate is provided with a pattern of pressure sensitive adhesive on the second face to create an adhesive coated area and an adhesive free area.

A second intermediate has first and second faces and is disposed within the second portion of the one of the repeating sequences of the carrier web. The second intermediate occupies approximately half of the one of the repeating sequences. The second intermediate has a longitudinal direction and a transverse direction that is less than the longitudinal direction. The longitudinal direction of the second intermediate is placed in the machine direction of the carrier web and the second intermediate is larger than the first intermediate.

Other features of the presently described embodiment include the second segment provided with plural lines of weakness that are perpendicular to the machine direction and the lines of weakness of the second segment in the machine direction. The additional lines of weakness are perpendicular to the machine direction and define a perimeter of an adhesive free area that is centrally disposed within the second segment.

Each of the first and second segments is provided with plural lines of weakness in the machine direction to define removable marginal areas.

The foregoing embodiments may also include other indicia such as bar codes or may have an RFID tag affixed to one or more components, such as to the second face of the packing list to aid in tracking and delivery of the parcel to which the shipping overlay assembly has been adhered.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a front view of the carrier web showing the packing list and shipping overlay in its intermediate configuration;

FIG. 2 shows the back or second face of the packing list and the adhesive patterns applied thereon;

FIG. 3 illustrates the back or second face of the shipping overlay and the adhesive patterns disposed thereon;

FIG. 4 depicts the pressure sensitive shipping assembly of the present invention applied to a surface of a carton and further illustrating the juxtapositioning of the components;

FIG. 5 shows a partially removed opening strip of the shipping overlay revealing the underlying packing list; and

FIG. 6 provides an illustration of the repeating sequences of the intermediate assemblies on a single carrier web.

### DETAILED DESCRIPTION OF THE INVENTION

The present invention is now illustrated in greater detail by way of the following detailed description, which represents the best presently known mode of carrying out the invention. However, it should be understood that this description is not to be used to limit the present invention, but rather, is provided for the purpose of illustrating the general features of the invention.

Surprisingly, it has been discovered that a highly efficient, simple and cost effective shipping overlay laminate assembly can be provided on a single carrier web and processed through a high speed applicator without the need of utilizing multiple webs, applicators and other related supporting apparatus. This innovative construction permits the easy installation of a list of contents to be readily and temporarily, centrally juxtaposed beneath an address shipping overlay in order to quickly ready a carton or package to be delivered to an end user customer.

The term “patterns” as used herein refers to strips, lines, shapes, spots, dots, elements and discontinuous segments as well as regular and irregular placement of such items. Patterns may also refer to combinations of the above mentioned items such that one pattern may be a continuous strip; another segmented elements; and a still further an irregular placement of elements or the like. Any combination of patterns is possible depending on the need or application of the manufacturer or the end user. In addition, the pattern can be prepared in order to accommodate a particular theme, season, event, trade dress, graphics, alpha and numeric characters, and the like.

As used herein the term “business communication piece or document” is used to refer to a substrate that either alone or in combination with other documents can convey a particular message, image or provide information about a particular product or service that is available from the provider of such pieces or documents. Business communication documents or pieces can include advertising, sales and marketing collateral and such other items used to convey information on written or imaged form sheets, brochures, presentation folders, informational sheets and combinations thereof.

The term “personalized information” refers to information that is printed or imaged onto a substrate and which is generally variable or unique and which changes from document to document so as to create a customized message or communication for each recipient. Examples of personalized information may include for example names, addresses, descriptions, plans, etc. that may have been acquired from the intended recipient such as surveys, questionnaires or answers given to various inquiries generated in response to a request for goods or services.

The term “static or fixed” information refers to printed or imaged information that generally does not change from document to document and may include a general description or body of information about a particular products, service, place, etc. that may be of interest to the intended recipient.

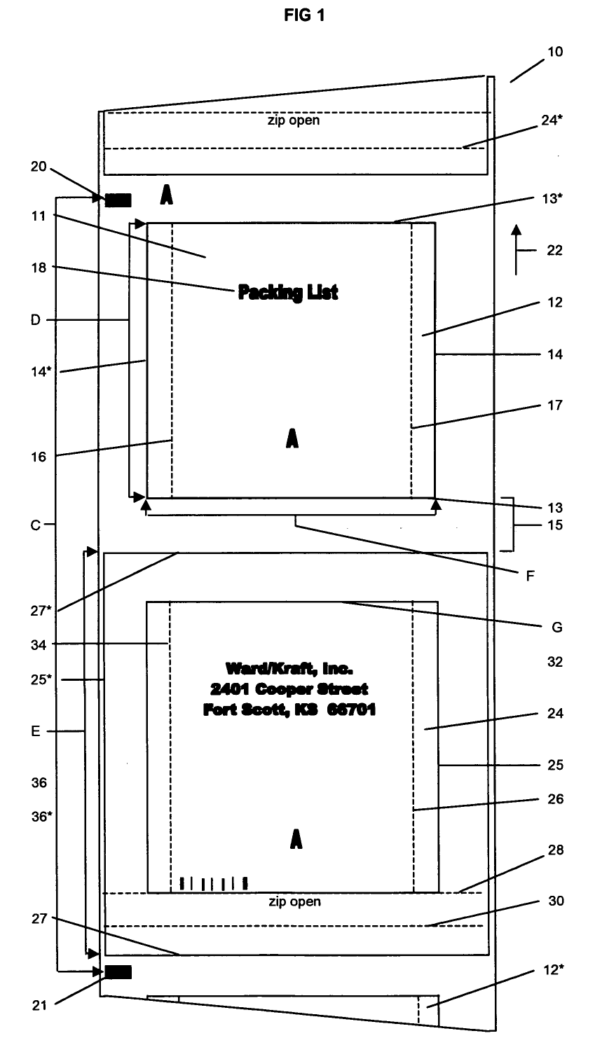

Turning now to FIG. 1, the invention is generally depicted by reference to numeral 10. The assembly depicted by 10 shows the construction in its intermediate arrangement, illustrating one intermediate segment and cut away portions showing repeating sequences of segments, which requires processing such as printing and application prior to the shipping overlay assembly being ready for use.

The term “intermediate” as used herein refers to a product that undergoes one or more processing steps prior to the intermediate reaching a final condition. The additional processing steps may include printing, imaging, folding, sealing, separating, cutting, perforating, scoring, adhering and the like. Typically, a product such as with the present invention is provided in an intermediate condition so that a user can add or manipulate the intermediate to create the final or desired end product, such as a shipping overlay or a sealed communication piece for business or personal use. Thus, the intermediate segment for example would be printed with variable and or personalized information prior to actual use of the assembly.

Still referring to FIG. 1, the carrier web 11 has top and bottom surfaces, the top surface is referenced as “A” in the present drawing. The carrier is made from a highly calendared, cellulosic based stock material and is coated with a release material such as silicone, wax, or other material that permits the packing list and shipping overlay to be readily removed from the web 11.

Disposed on the carrier web 11 is a packing list 12, which is preferably selected from thermally sensitive stock materials such that the stock may be imaged by a thermal printer. The packing list 12 has first and second longitudinally extending sides 14 and 14* as well as first and second transversely extending end edges 13 and 13*. The packing list 12 has first (referenced by the letter “A”) and second faces (shown in a later figure). The first face “A” of the packing list 12 is printed with variable or personalized indicia 18 that relates, for example, to the particulars of an order, message for the customer or end user, or other information.

The packing list 12 is also provided with first and second longitudinally extending lines of weakness 16 and 17 which are spaced inwardly of longitudinally sides 14 and 14* to create marginal areas that will be provided with patterns of adhesive on the second face and as will be later described herein.

The packing list 12 has a length represented by the letter “D” which is equivalent to the length of the longitudinal sides (14/14*) of the packing list. The packing list 12 also has a width that is represented by the letter “F” and which is equivalent to the width of the transverse end edges (13/13*).

The carrier web 11 is also provided with sense marks 20 and 21, which generally will be used to create repeating sequences of the intermediate shipping overlay assembly. The sense marks are spaced from one another the entire length or distance of a single intermediate assembly and that length is referenced by the letter “C”. The leading and trailing edges (transversely extending edges) of the packing list and shipping overlay may also be used as signals to stop and start the intermittent movement of the intermediate on the carrier web. Thus, the length of the intermediate would then be the distance from the leading edge of the first portion of the intermediate assembly, in this embodiment the packing list, to the trailing edge of the second portion of the intermediate assembly, in this embodiment the shipping overlay. In the present embodiment, the shipping intermediate may have a length of about 14¾ inches to about 16 inches depending on the spacing between the two portions of the intermediate.

The longitudinal direction of the web 11 and packing list 12 and shipping overlay 24 are shown in the direction of machine travel or machine direction and which is illustrated by reference numeral 22.

Still referring to FIG. 1, the shipping overlay 24 has a length and width, which are referenced by the letter designations “E” and “G”, respectively. The shipping overlay 24 has first and second longitudinal sides 25 and 25* and first and second transversely extending end edges 27 and 27*.

The shipping overlay 24 is provided with first and second lines of weakness including lines 26 and 34 which run generally parallel to the longitudinal sides 25 and 25* and are spaced inwardly from the lines. Lines of weakness 26 and 34 of the shipping overlay 24 as well as lines 16 and 17 of the packing list 12 also generally run parallel to the direction of machine travel 22.

The shipping overlay 24 is also provided with first and second lines of weakness 28 and 32 that run parallel to the transverse end edges 27 and 27* and perpendicular to the direction of machine travel 22. The lines of weakness cooperate to form the outer perimeter of the adhesive free area that is centrally disposed of the shipping overlay label.

The shipping overlay 24 also has first and second faces, the first face depicted by the letter “A” and the second face to be discussed later in connection with another drawing. Preferably, the shipping overlay 24 has a thermosensitive coating such that a thermal printer may be used to image information 36 such as address or recipient information. Other indicia may of course be printed such as bar codes 36*.

While in the presently described embodiments of the present invention, each of the packing list 12 and shipping overlay have been described as having a thermosensitive coating, it should be understood that other printable medium may be used. For example, there may be no special coating on the stock or the stock may have toner adhesion or ink jet ink receptive coatings so that the form assembly may be used with all sorts of equipment.

FIG. 1 also provides, the repeating sequence of intermediate portions such as the packing list portion 12* and shipping overlay 24* portions of each of which are shown in the partial cut away of the carrier web 11. It should be understood that each intermediate assembly is made up of repeating segments of a packing list and a shipping overlay label with the two portions, and the space between the two, being equal to one intermediate assembly of the present invention.

The length “C” of the intermediate assembly on the carrier web 11 represents a first distance that is greater than the combined lengths of the packing list 12 represented by letter “D” and the shipping overlay 24, represented by the letter “E”. Spacing between the packing list 12 and the shipping overlay 24 is represented by the numeral 15 and is less than five inches, preferably less than two inches and more preferably less than one inch. The combined lengths of the packing list, shipping overlay and spacing will be generally equivalent to the length of one intermediate assembly that is represented by the character designation “C”.

The shipping overlay 24 has transversely extending lines of weakness 28 and 30 that run substantially completely between the longitudinal sides 25 and 25* and cooperate with one another to form a tear off strip (depicted by reference to the term “zip open” shown in the drawing). Removal of this strip as will be described later and the strip are used to lift the shipping overlay such that it will reveal the underlying packing list once the assembly is in its final juxtaposed relationship. The longitudinal lines of weakness 28 and 30 are generally longer than the longitudinal lines of weakness of the packing list 16 and 17.

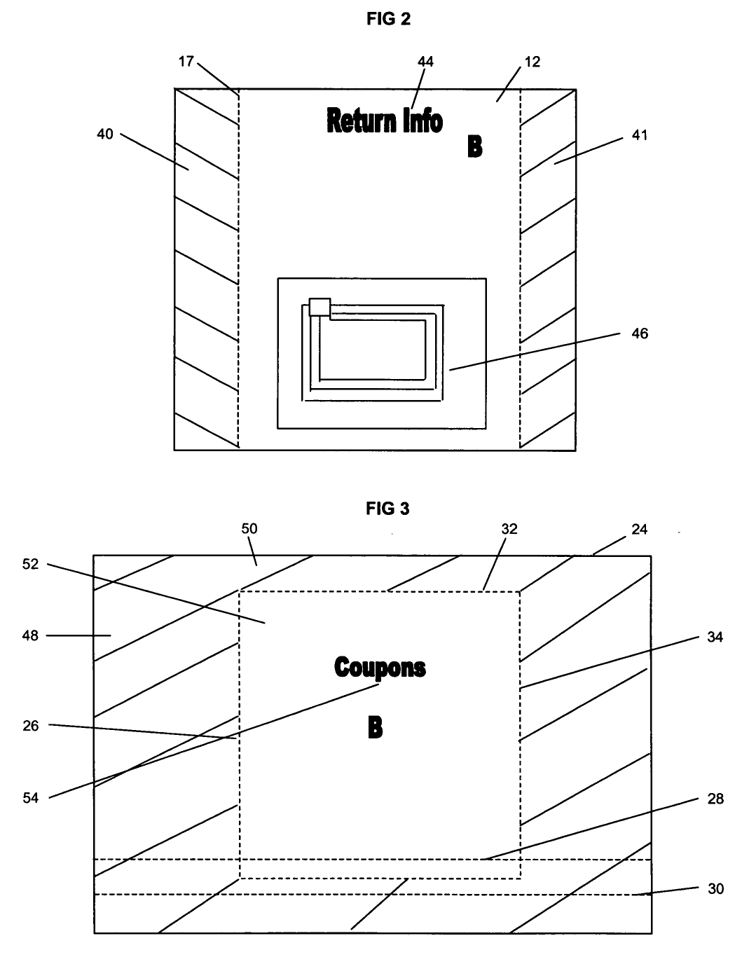

The packing list 12 has dimensions of approximately 5 inches by 6 inches and an adhesive free area as shown in FIG. 2 of approximately 4¼ inches by 6 inches. The shipping overlay 24 has dimensions of approximately 6 inches by 8 inches with an adhesive free area as shown in FIG. 3 of approximately 4¼ inches by 6 inches. From these dimensions it can be rationalized that the shipping overlay is larger than the packing list upon which it is ultimately juxtaposed (in both the longitudinal and transverse directions) and that marginal areas of the shipping overlay extend beyond the sides of packing list so that the overlay is attached to both the carton or package and underlying packing list. The adhesive free areas of each of the portions or segments are substantially of the same dimensions so that when the segments overlap one another the adhesive free areas approximately match up with one another, that is, they are approximately the same size or dimension.

Turning now to FIG. 2, the second face of the packing list 12, designated by reference to the letter “B” is shown. Longitudinally extending lines of weakness 16 and 17 are spaced inwardly from the longitudinally extending sides and define marginal regions. In these marginal areas, patterns of adhesive 40 and 41 are applied. The adhesive will preferably be a permanent adhesive but other adhesives may be used depending on the needs of the end user or customer. The lines of weakness 16 and 17 will permit the packing list central portion 42, which is devoid of adhesive and provides an adhesive free area to be removed while the marginal portions remain affixed to the carton or box to which the assembly was applied.

The adhesive is typically a permanent pressure sensitive adhesive and may be applied through use of hot melt screen coaters and is applied generally in a machine direction.

FIG. 2 also provides that indicia 44 may be printed. Such indicia may be static or personalized, depending on the requirements of the end user and may include return information, or other information relevant to the package or consumer. In addition, to the second face “B” of the packing list 12 an RFID tag 46 is applied to aid the tracking of the package in the event the human visible information is unable to be read or scanned by a line of sight device. The tag will typically be a passive tag such as available from Texas Instruments of Fort Worth, Tex. or a battery-assisted tag such as is available from PowerPaper of Tel Aviv, Israel. Removal of the center portion 42 will also remove the RFID tag 46. A further line of weakness (not shown) may be added to separate the RFID tag 46 from the human readable indicia 44.

The RFID tag is merged with the packing list during the formation of the carrier web and the intermediate shipping overlay assembly.

Reference is now directed to FIG. 3 of the present invention in which the second face, depicted again through the use of the letter “B”, of the shipping overlay 24 is provided. As discussed in connection with FIG. 1, the shipping overlay 24 is provided with a series of lines of weakness, at least two provided running parallel to the transverse direction 28 and 32 (perpendicular to the machine direction) and two running parallel to the longitudinal direction 26 and 34. All of the lines of weakness are spaced inwardly of their respective sides or edges and a pattern of adhesive 48 and 50 is applied in the marginal areas created by the lines of weakness. The lines of weakness 28, 32, 26 and 34 further define the outer perimeter of an adhesive free area 52. As shown in this FIG. 3, adhesive free area 52 may be printed with additional information 54 or as shown may include a coupon good toward future purchases or a rebate to be used in connection with the present purchase.

The adhesive free areas of each of the packing list and shipping overlay are equal to at least about 50% of the area of the back of the intermediate. The packing list adhesive free area ranges from about 50% to 70% of the total area of the packing list. The shipping overlay adhesive free area ranges from about 50% to 60% of the total area of the shipping overlay. In this fashion, more than half of the area of each of the first and second faces of each of the intermediates is available for printing or imaging.

As will be discussed later, the adhesive free area 52 of the shipping overlay 24 is sized and configured so as to substantially cover the adhesive free area 42 of the packing list. The adhesive free area 52 of the shipping overlay 24 is in contact with the top face “A” of the packing list 12. The adhesive free area 44 of the packing list 12 is in contact with the carton or package. While in the intermediate condition, that is still affixed to the web, the adhesive free areas of both the packing list and shipping label are in contact with the release coated face of the web.

By placing the shipping overlay with the adhesive free area in contact with the central portion of the face “A” of the packing list this arrangement will allow the shipping overlay to be removed without damaging the indicia provided on the first face “A” of the packing list 12. Likewise, removal of the packing list 12 from the carton will permit the personalized or variable information printed on the second face “B” of the packing list to be easily removed.

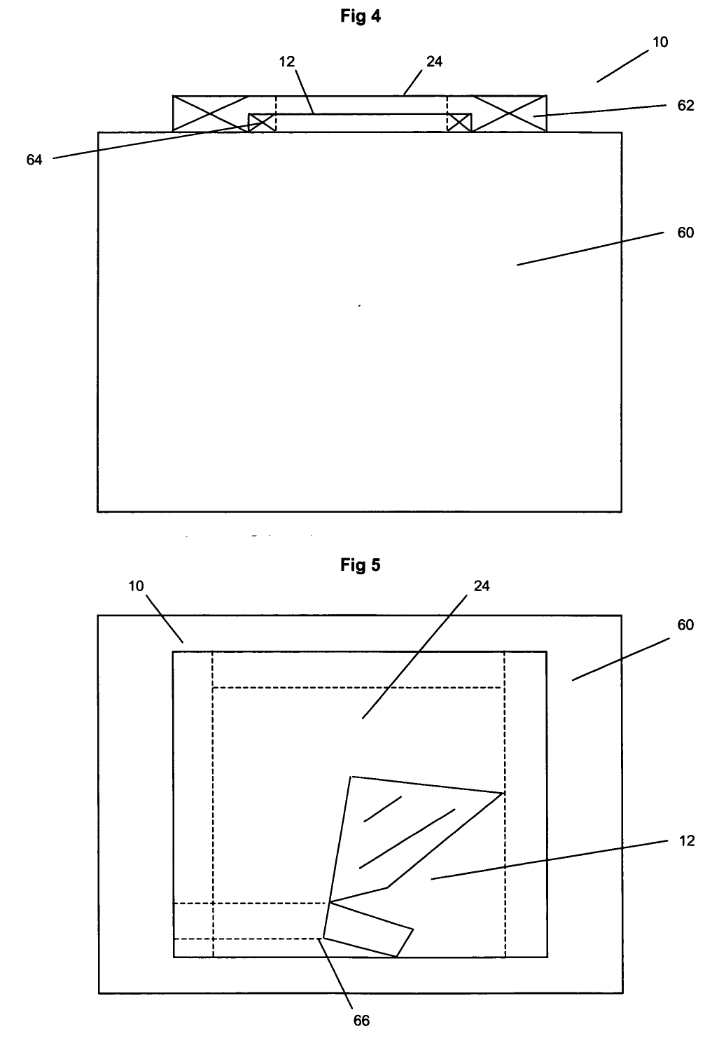

Attention is now directed to FIG. 4 of the present invention in which the presently described shipping overlay assembly 10 has been applied to a carton or box 60 that is suitable for delivery by a courier service such as the US Postal Service, UPS®, FEDEX®, DHL® and the like. The shipping overlay assembly 10 will be adhered to the box through the use of the adhesive that is provided on the back or second faces of each of the packing list 12 and shipping overlay 24. The adhesive 62 of the shipping overlay 24 connects the overlay 24 to the carton 60 as well as to the top face or surface of the packing list 12. The adhesive 64 of the packing list 12 is used to adhere the packing list to the surface of the box 60.

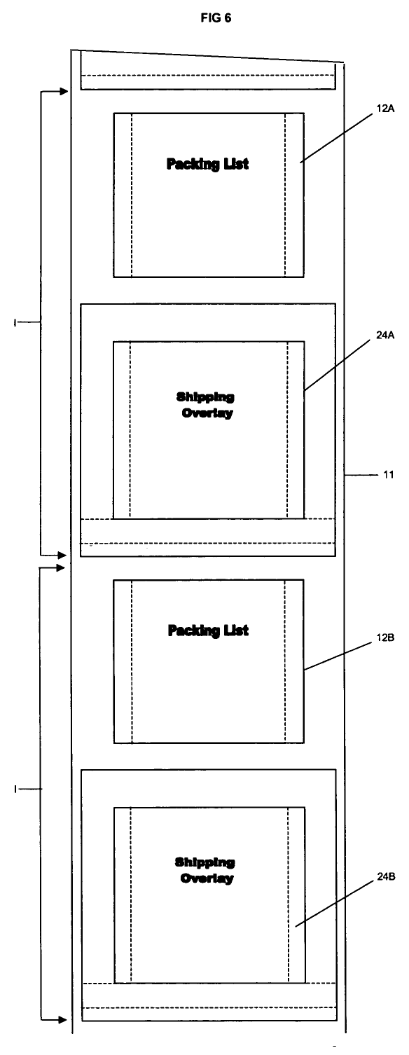

Referring now to FIG. 5, the overlay assembly 10 is affixed to the surface of the carton 60. The removable strip 66 of the shipping overlay 24 has been peeled partly away so that the packing list 12 is visible. In this arrangement it can again be seen that the shipping overlay completely covers the packing list and that the adhesive free area of the shipping overlay as previously described does not interfere with the packing list.

FIG. 6 is provided to illustrate the repeating sequences of the intermediate assemblies provided on the carrier web. FIG. 6 shows two intermediate sequences depicted by 12a and 24a (packing list and shipping overlay label, respectively) and 12b and 24b (packing list and shipping overlay label, respectively) showing in a repeating spaced relationship to one another. The carrier web 11 would be provided with a number of identical sequences each of which repeat.

FIG. 6 is also used to illustrate the first and second intermediates of the intermediate assembly, with the packing list 12a making up the first portion of the intermediate assembly and the shipping overlay label 24a making up the second portion of the pressure sensitive laminate intermediate assembly. The length of each intermediate assembly is indicated by reference to the Roman numeral “I”.

The first intermediate or packing list 12a is spaced from the second intermediate or shipping overlay label 24a a distance of less than 5 inches, preferably less than 2 inches and still more preferably between 0.001 inch to 0.5 inch. The first intermediate 12a will be shorter in length than the second intermediate 24a and the second intermediate 24a will be wider than the first intermediate 12a of the intermediate assembly.

In using the assembly of the present invention, the web is advanced to a printer applicator and the packing list is first printed with information relating to the contents of the package to which it will ultimately be affixed. Variable or personalized messages or indicia may also be added to assist the customer in using the contents, allowing for the return of all or a portion of the order or a marketing message tailored to the particular recipient. The carrier web is the advanced and the packing list removed, such as by a picker arm or vacuum plunger, and then is placed on a package. Next, the shipping overlay is printed with address information, as well as with any variable information that may be applicable to the user or merchandiser, the web is again advanced and the shipping overlay removed and affixed over the top of the packing list.

As indicated previously, the adhesive free area of the packing list is in contact with the exposed surface of the carton or package. The adhesive free area of the shipping overlay is in contact with the face of the packing list.

The intermediates of the present invention can be used to convey personalized or variable information to the recipient or end user. The shipper can apply coupons, discount messages, specific return or use information, ideas for products or services, account information, promotional offerings and the like. The information can be printed or imaged on either face of either of the intermediates depending on the needs of the shipper or end user.

In the event that multiple packing lists are required, instructions are provided to the printer applicator to not print the shipping overlay but to instead remove the overlay and then advance the web so that the next packing list can be printed and then applied over the first packing list. If sufficient packing lists are printed then a shipping overlay is printed and placed on the stack of packing lists.

It will thus be seen according to the present invention a highly advantageous pressure sensitive packing system overlay has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A pressure sensitive packing list overlay assembly, comprising;
a carrier web having first and second faces and a width and a length, said first face of said carrier web is coated with a release material and said second face is uncoated and one of said first and second faces is provided with at least first and second marks so as to be discernable by an electronic sensor and said first and second marks are spaced from one another a first distance in a machine direction substantially equal to a length of a complete pressure sensitive overlay intermediate assembly;
said pressure sensitive overlay assembly including a packing list and a shipping overlay spaced from one another a second distance on said carrier web and on said first face that is less than said first distance;
said packing list having first and second faces and first and second longitudinally extending sides and first and second transversely extending edges, said packing list having a width and length creating a packing list area having a first dimension, said packing list second face is provided with a first and second longitudinally extending lines of weakness spaced inwardly from first and second longitudinally extending sides to create marginal areas, a pressure sensitive adhesive pattern is applied in at least said marginal areas of said longitudinally extending sides leaving a central portion of said packing list second face substantially devoid of adhesive and said first face of said packing list is provided with variable indicia;
said longitudinally extending lines of weakness and said transversely extending edges of said packing list cooperating to form an outer perimeter of an adhesive free area on said packing list and said adhesive free area having an adhesive free area; and
said shipping overlay having first and second faces and first and second longitudinally extending sides and first and second transversely extending edges, said shipping overlay having a width and length creating a shipping overlay area having a second dimension greater than said first dimension of said packing list, first and second longitudinally extending lines of weakness are spaced inwardly from each of said longitudinally extending sides and first and second transversely extending lines of weakness are spaced inwardly from each of said transversely extending edges to create marginal areas, said second face of said shipping overlay is provided with an adhesive pattern within said marginal areas of each of said first and second longitudinally extending sides and said first and second transversely extending edges and extending inwardly from each of said sides and edges, with each of said marginal areas of said longitudinally extending sides being substantially equal and said marginal areas of said transversely extending ends being substantially equal, said lines of weakness cooperating to form an outer perimeter of an adhesive free area disposed substantially centrally of said shipping overlay and said area is greater than said adhesive free area of said packing list.

2. A pressure sensitive packing list overlay assembly as recited in claim 1, wherein said carrier web has a plurality of repeating predefined sequence arrangements of said packing list followed by said shipping overlay that are spaced from one another in a machine travel direction less than two inches.

3. A pressure sensitive packing list overlay assembly as recited in claim 1, wherein said shipping overlay is provided with a third transversely extending line of weakness spaced from and parallel to one of said first and second transversely extending lines of weakness.

4. A pressure sensitive packing list overlay assembly as recited in claim 1, wherein said first and second longitudinally extending lines of weakness are contained entirely within said second dimension of said shipping overlay and each having a length that is greater than said length of said packing list.

5. A pressure sensitive packing list overlay assembly as recited in claim 1, wherein at least one of said first and second transversely extending lines of weakness is contained entirely within said second dimension of said shipping overlay and extends a distance that is greater than said width of said packing list.

6. A pressure sensitive packing list overlay assembly as recited in claim 1, wherein said first and second longitudinally extending lines of weakness of said packing list extend substantially entirely between said first and second transversely extending edges.

7. A pressure sensitive packing list overlay assembly as recited in claim 1, wherein said first face of each of said packing list and said shipping overlay are coated with a thermally sensitive material.

8. A pressure sensitive packing list overlay assembly as recited in claim 1, wherein said adhesive of said shipping overlay substantially entirely surrounds said adhesive free area of said shipping overlay.

9. A pressure sensitive packing list overlay assembly as recited in claim 1, wherein said packing list has an RFID tag affixed thereto.

10. A pressure sensitive package delivery construction, comprising;
a package suitable for delivery via a courier service, said package having at least one exposed surface suitable for receiving a pressure sensitive laminate assembly providing delivery instructions and content information;
said pressure sensitive laminate assembly provided on a single, continuous web, said pressure sensitive assembly having first and second portions that are placed on said web in an alternating and repeating fashion and define a length of an intermediate assembly used to construct said laminate assembly;
said length of said intermediate assembly is greater than combined lengths of said first and second portions;
said first portion having a first length and width creating a first area, first and second faces and first and second ends and first and second sides, said second face is provided with regular patterns of pressure sensitive adhesive spaced from one another and creating at least one adhesive free area between said patterns, said at least one adhesive free area is further defined by plural lines of weakness creating outer edges of said adhesive free area;
said pressure sensitive laminate assembly including said second portion having a first length and width creating a second area larger than said first area, first and second faces and first and second ends and first and second sides, said second face is provided with regular patterns of pressure sensitive adhesive spaced from one another and creating at least one adhesive free area between said patterns, said at least one adhesive free area of said second portion is larger than said adhesive free area of said first portion, said at least one adhesive free area is further defined by plural lines of weakness that create outer edges of said at least one adhesive free area of said second portion; and
each of said first and second portions of said pressure sensitive laminate are removed from said single carrier web and placed on said exposed surface of said package such that said first portion is placed substantially centrally temporarily beneath said second portion and said first portion is removed subsequent to second portion being removed by said lines of weakness.

11. A pressure sensitive package delivery construction as recited in claim 10, wherein said plural lines of weakness of said second portion are in substantial parallel alignment when said second portion is juxtaposed on said first portion.

12. A pressure sensitive package delivery construction as recited in claim 10, wherein said adhesive free area of said first portion is in substantial parallel alignment with said adhesive free portion of said second portion when said second portion is juxtaposed on said first portion.

13. A pressure sensitive package delivery construction as recited in claim 10, wherein one of said first and second portions is provided with an RFID tag.

14. A pressure sensitive package delivery construction as recited in claim 10, wherein said width of said first portion is less than said width of said second portion.

15. A pressure sensitive package delivery construction as recited in claim 10, wherein said first and second portions are spaced from one another in a machine travel direction less than two inches.

16. A pressure sensitive package delivery construction as recited in claim 10, wherein said adhesive patterns applied to said second portion surrounds said adhesive free area.

17. A pressure sensitive shipping assembly intermediate, comprising;
a carrier web having first and second surfaces, said carrier web constructed from highly calendared cellulosic stock, said first surface having a coating of release material provided thereon, and said carrier web is provided with a plurality of repeating sequences of length in a machine direction with each of said sequences having first and second portions;
said carrier web is provided with first and second intermediate portions that are spaced from one another in said machine direction a distance of less than a length in said machine direction equal to said first portion of said repeating sequence.
a first intermediate having first and second faces and disposed within said first portion of one of said repeating sequences of said carrier web and occupying less than half of said one of said repeating sequences, said first intermediate having a longitudinal direction and a transverse direction that is less than said longitudinal direction, said longitudinal direction placed in said machine direction of said carrier web;
said first intermediate is provided with a pattern of pressure sensitive adhesive on said second face to create an adhesive coated area and an adhesive free area; and
a second intermediate having first and second faces and disposed within said second portion of said one of said repeating sequences of said carrier web and occupying approximately half of said one of said repeating sequences, said second intermediate having a longitudinal direction and a transverse direction that is less than said longitudinal direction, said longitudinal direction placed in said machine direction of said carrier web, said second intermediate is larger than said first intermediate.

18. A pressure sensitive shipping assembly intermediate as recited in claim 17, wherein each of the first and second segments are provided with plural lines of weakness in said machine direction to define removable marginal areas.

19. A pressure sensitive shipping assembly intermediate as recited in claim 18, wherein said second segment is provided with plural lines of weakness that are perpendicular to said machine direction and said lines of weakness of said second segment in said machine direction and said lines of weakness perpendicular to said machine direction define a perimeter of an adhesive free area centrally disposed within said second segment.

20. A pressure sensitive shipping assembly intermediate as recited in claim 17, wherein said adhesive patterns are applied to said first segment and are applied only in said machine direction.
